(19) United States
(12) Patent Application Publication
(10) Pub. No.: US 2026/0361143 A1
(43) Pub. Date: Nov. 12, 2026

(54) SHIELD STRUCTURES FOR CHARGING PUCKS

(71) Applicant: Apple Inc., Cupertino, CA (US)

(72) Inventors: James C. Wu, Redwood City, CA (US); Vi Phan, San Diego, CA (US); Rajesh Saliya, San Jose, CA (US); Grant S. Haug, Mountain View, CA (US); Jun-Ya Fong, San Francisco, CA (US); Dao Kai Lim, San Jose, CA (US)

(73) Assignee: Apple Inc., Cupertino, CA (US)

(21) Appl. No.: 19/675,244

(22) Filed: May 12, 2026

Related U.S. Application Data
(60) Provisional application No. 63/804,561, filed on May 12, 2025.

(51) Int. Cl. H02J 50/70; H02J 7/70; H02J 50/00; H02J 50/10

(52) U.S. Cl. CPC H02J 50/70; H02J 7/70; H02J 50/005; H02J 50/10

(57) ABSTRACT

Structures that can simplify the design, manufacturing, and assembly of charging devices, such as charging pucks. In one example, the design, manufacturing, and assembly of charging pucks can be simplified by combining the features of two or more charging puck components into a reduced number of components. In this example, two or more charging puck components can be combined into a single component. In this example, a contacting surface and an e-shield can be combined into a single top cap structure.

### CROSS-REFERENCES TO RELATED APPLICATIONS

This application claims the benefit of U.S. Provisional Application No. 63/804,561, filed on May 12, 2025, which is incorporated by reference.

### BACKGROUND

Electronic devices have become ubiquitous. Wearable computing devices, portable computing devices, audio devices, and others accompany us throughout the day. These devices typically include batteries that are used to power them. Often, the batteries in these devices can be recharged using charging devices, such as charging pucks.

As a result, these charging pucks have become commonplace. Accordingly, it can be desirable to be able to provide these charging pucks to users in an efficient manner. That is, it can be desirable to simplify the design, manufacturing, and assembly of charging pucks such that demand for them can be more readily satisfied.

Thus, what is needed are structures that can simplify the design, manufacturing, and assembly of charging devices, such as charging pucks.

### SUMMARY

Accordingly, embodiments of the present invention can provide structures that can simplify the design, manufacturing, and assembly of charging devices, such as charging pucks. In an illustrative embodiment of the present invention, the design, manufacturing, and assembly of charging pucks can be simplified by combining the features of two or more charging puck components into a reduced number of components. In these and other embodiments of the present invention, two or more charging puck components can be combined into a single component.

In these and other embodiments of the present invention, the functions of two charging puck components can be combined into one structure. For example, a charging puck can include a top cap that provides a contacting surface to mate with an electronic device while the electronic device is charged by the charging puck. The charging puck can further include an e-shield for limiting electromagnet interference and reducing electric fields at a charging surface of the charging puck. These and other embodiments of the present invention can include the e-shield functionality in the contacting surface to form a top cap for the charging puck. This consolidation can simplify the design, manufacturing, and assembly of the charging puck.

In these and other embodiments of the present invention, a top cap can be formed by doping the top cap with a conductive material to provide the function of an e-shield. The employment of doping in the top cap can improve charging by removing a physical layer between an electronic device and a charging coil in the charging puck, thereby shortening the spatial distance between them. This reduction in spacing can help to increase an efficiency of the charging of the electronic device.

The electrically conducive nature of such a top cap can limit the electric field and emissions at a surface of the top cap. But when the resistance of an e-shield is low, eddy currents can flow in the e-shield, and this can degrade the inductive coupling of the charging coil to a corresponding charging coil in the electronic device. Accordingly, embodiments of the present invention can use carbon doping to provide electrical conductivity to the top cap. Other types of doping, such as silver or other conductive material, can be used. Specifically, the top cap can be formed of resin, plastic, nylon-based plastic, or other materials. This resin or other material can be doped with carbon, silver, or other material.

This top cap can provide a contacting surface for interfacing with an electronic device when the electronic device is charged by the charging puck. A contacting surface formed of carbon doped plastic would typically be black, which might or might not be desirable. Accordingly, embodiments of the present invention can combine conductive carbon or other conductive material doping with a separate layer of plastic or other material that provides the capability of forming a top cap having a color other than black.

For example, in these and other embodiments of the present invention, a top cap can be formed using a two-shot process where a first shot forms a contacting surface for interfacing with an electronic device while charging, and a second shot provides a layer having the function of an e-shield. The first layer can be visible and can be made to have different colors as desired. The second layer might not be visible and might not contribute to the appearance of the charging puck. For example, the first layer can be a thermally conductive layer to help to remove heat from the electronic device while it is being charged. The first shot can form a first layer, which can be formed of plastic, nylon-based plastic, or other material. The second shot can form the second layer, which can be formed of plastic, nylon-based plastic, or other material that is doped with carbon, silver, or other material to provide the function of an e-shield.

These shots can be various types of molding shots in these and other embodiments of the present invention. For example, either or both the first and second shots can be formed by injection molding. Either or both the first and second shots can be formed by low-injection-pressure overmold (LIPO.) The use of LIPO can enable a layer to have a decreased thickness. This decreased thickness can help to increase an efficiency of the charging of an electronic device by a charging device, such as a charging puck.

These and other embodiments of the present invention can provide a top cap formed of a thermally conductive layer to help to remove heat from the electronic device while it is being charged. The thermally conductive layer can be formed of plastic or other material. For example, the thermally conductive layer can be formed of a nylon-based plastic. An underside of the thermally conductive layer of the top cap can be coated with a layer of carbon, silver, or other electrically conductive material to form an e-shield. The coating can be formed by pad printing, vapor deposition, jet spraying, 3D printing, or other method.

One or more layers of graphene can be placed on the underside of the top cap. Graphene can be used to provide both thermal and electrical conductivity. These various conductive layers can have a sheet resistance on the order of between 100 and 1,000 ohms per square, or they can have another sheet resistance.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 is an exploded view of a charging puck according to an embodiment of the present invention;

FIG. 2 illustrates a top cap according to an embodiment of the present invention;

FIG. 3 is a cutaway sideview of a portion of a charging puck according to an embodiment of the present invention;

FIG. 4 illustrates another top cap according to an embodiment of the present invention;

FIG. 5 is another cutaway sideview of a portion of a charging puck according to an embodiment of the present invention;

FIG. 6 illustrates another top cap according to an embodiment of the present invention;

FIG. 7 is another cutaway sideview of a portion of a charging puck according to an embodiment of the present invention;

FIG. 8 illustrates a connection between a top cap and a housing for a charging puck according to an embodiment of the present invention;

FIG. 9 illustrates a structure for reducing eddy currents in a conductive layer of a charging puck according to an embodiment of the present invention; and

FIG. 10 illustrates another connection between a top cap and a housing for a charging puck according to an embodiment of the present invention.

### DESCRIPTION OF ILLUSTRATIVE EMBODIMENTS

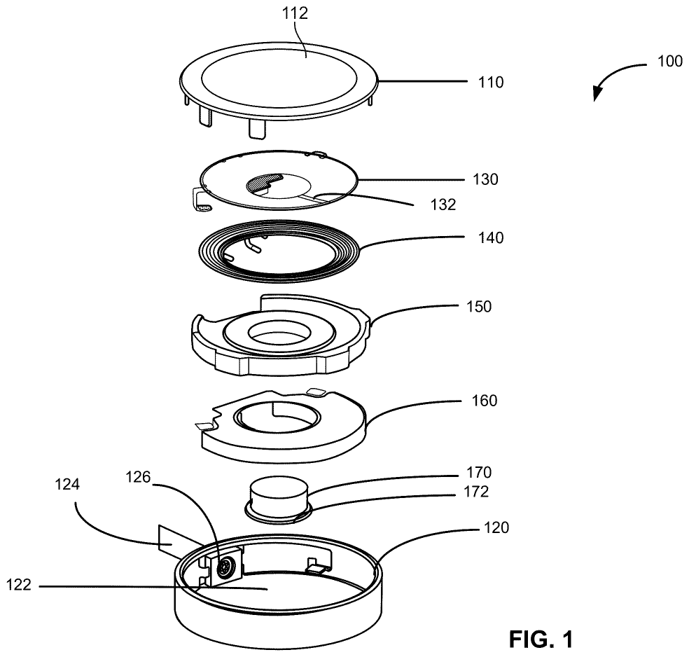

FIG. 1 is an exploded view of a charging puck according to an embodiment of the present invention. This figure, as with the other included figures, is shown for illustrative purposes and does not limit either the possible embodiments of the present invention or the claims.

Charging puck 100 can include top cap 110, housing 120, e-shield 130, charging coil 140, ferrite 150, control electronics 160, magnet 170, and magnetic shield 172.

Cable 124 can include conduits 126 for conveying power from an external source (not shown) to control electronics 160. Control electronics 160 can use this power to provide waveforms to drive currents in charging coil 140. E-shield 130, charging coil 140, ferrite 150, control electronics 160, magnet 170, and magnetic shield 172 can be housed in recess 122 of housing 120.

Contacting surface 112 of top cap 110 can provide a surface for engaging with an electronic device (not shown) that is being charged by the charging puck 100. The electronic device can be a watch, ring, earbuds, headphones, or other wearable electronic device or wearable computing device. The electronic device can be another type of device, such as a headset, phone, laptop, tablet, or other portable computing device or other electronic device. Contacting surface 112 of top cap 110 can present an aesthetically pleasing surface to a user of charging puck 100.

E-shield 130 can be formed of a low resistance material to block electromagnetic fields and emissions from coil 140. E-shield 130 can include slot 132 to increase the impedance of e-shield 130 to induced or eddy currents that would otherwise reduce coupling efficiency between coil 140 and a corresponding coil in the electronic device being charged.

Coil 140 can be located on ferrite 150. Ferrite 150 can redirect magnet fields created by coil 140 towards contact surface 112 of top cap 110 to improve magnetic field coupling to a corresponding coil in the electronic device being charged.

Magnet 170 can work in concert with a corresponding magnet in the electronic device to align and attach the electronic device to charging puck 100. Magnet 170 can be various types of magnets, such as a permanent magnet. Magnet 170 can be a Z-pole radial magnet or other magnet as described in co-pending U.S. patent application Ser. No. ______, having attorney docket number 090911-P72279US1, which is incorporated by reference. Magnet 170 can be positioned on magnetic shield 172. Magnetic shield 172 can act as a backplate to direct magnetic flux towards a corresponding magnet in an electronic device being charged.

In these and other embodiments of the present invention, two or more of these components can be combined in order to simplify the design, manufacturing, and assembly of charging puck 100. The combination of components can also help to reduce a spacing or distance between coil 140 and a corresponding coil in an electronic device when the electronic device is being charged, thereby improving coupling efficiency.

In these and other embodiments of the present invention, top cap 110 can include the benefits and functionality of e-shield 130 to form a top cap, such as top cap 210, top cap 410, top cap 610, top cap 810, and top cap 1010 as shown below, along with other top caps provided by these and other embodiments of the present invention.

These top caps can include a conductive layer to block electric field emissions from coil 140. The conductivity of the conductive layer can be limited to restrict the creation of induced or eddy currents in the conductive layer. In the charging puck 100 in FIG. 1, a slot 132 can be cut in e-shield 130 to prevent induced or eddy currents in e-shield 130. Instead of a slot in the conductive layer, the conductivity of the conductive layer in the top cap can be limited. An example is shown in the following figure.

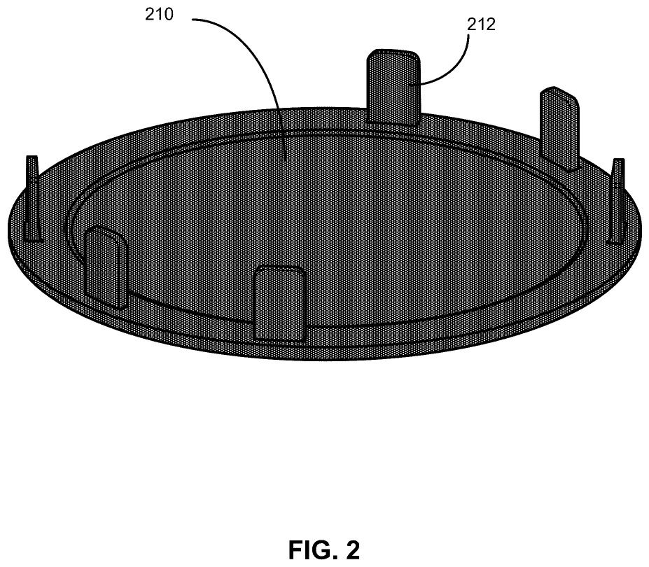

FIG. 2 illustrates a top cap according to an embodiment of the present invention. Top cap 210 can be formed of a resin, plastic, nylon-based plastic, or other material. This material can be thermally conductive to conduct heat away from an electronic device being charged by a charging puck incorporating top cap 210. Top cap 210 can be doped with carbon, silver, or other material. The doping can provide conductivity that can help to block electric field emissions from coil 140. Using carbon can provide conductivity of a limited amount to prevent induced or eddy currents in top cap 210 that would otherwise limit charging efficiency. Accordingly, top cap can have sheet resistance on the order of 100 to 1,000 ohms per square. Top cap 210 can include tabs 212 to connect top cap 210 to housing 120 (shown in FIG. 1.)

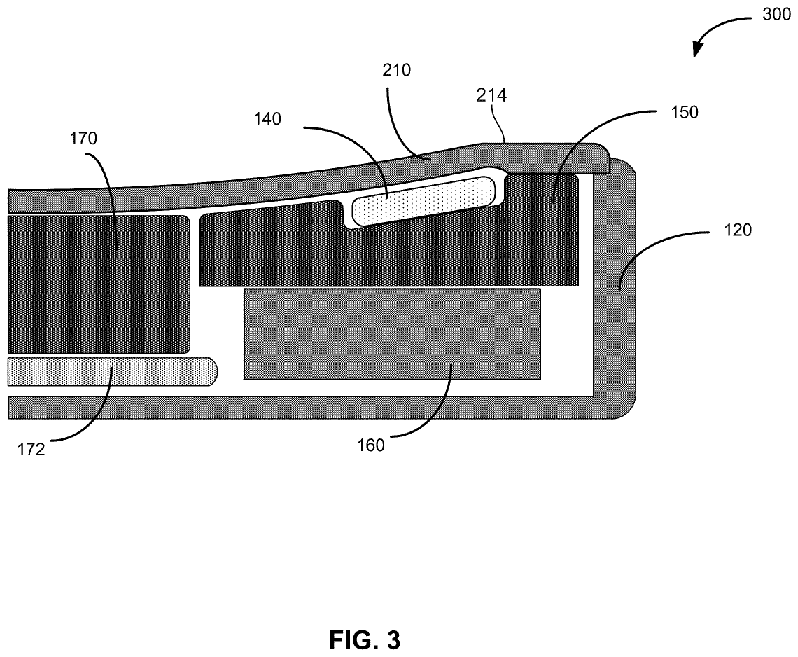

FIG. 3 is a cutaway sideview of a portion of a charging puck according to an embodiment of the present invention. Charging puck 300 can include top cap 210 and housing 120. Top cap 210 and housing 120 can house magnet 170, magnetic shield 172, charging coil 140, ferrite 150, control electronics 160, a subset of these, or some or all of these and other components. Top cap 210 can connect to housing 120 or other conductive structure of charging puck 300 using a conductive glue or a conductive pressure sensitive adhesive (PSA.) In this way, the conductive glue or PSA can be used to bridge the connection from the conductive layer of top cap 210 to system ground, which can be housing 120 or another part in the system. The glue or PSA can be attached to tabs 212, shown in FIG. 2.

Again, the use of carbon doping in resin or plastic for top cap 210 can provide a top cap that can limit electric field emissions while also limiting the formation of induced or eddy currents. This use of carbon can provide a black surface 214 that is viewable by users. In these and other embodiments of the present invention, a color other than black or a variety of colors can be desirable. Accordingly, these and other embodiments of the present invention can provide top caps having visible surfaces having different colors. Examples are shown in the following figures.

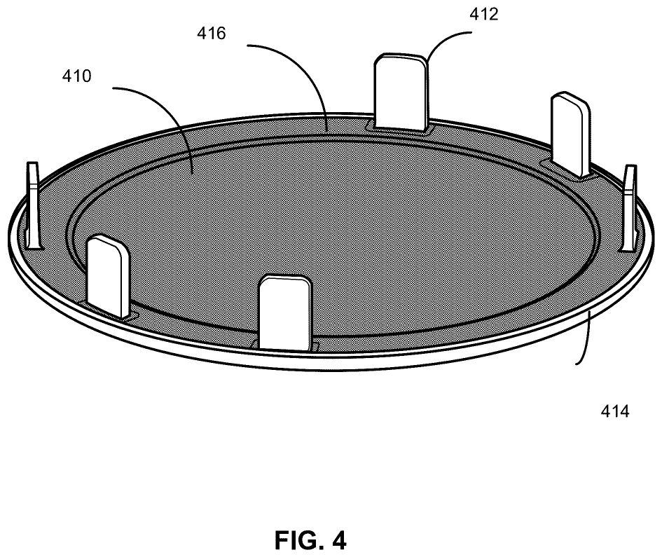

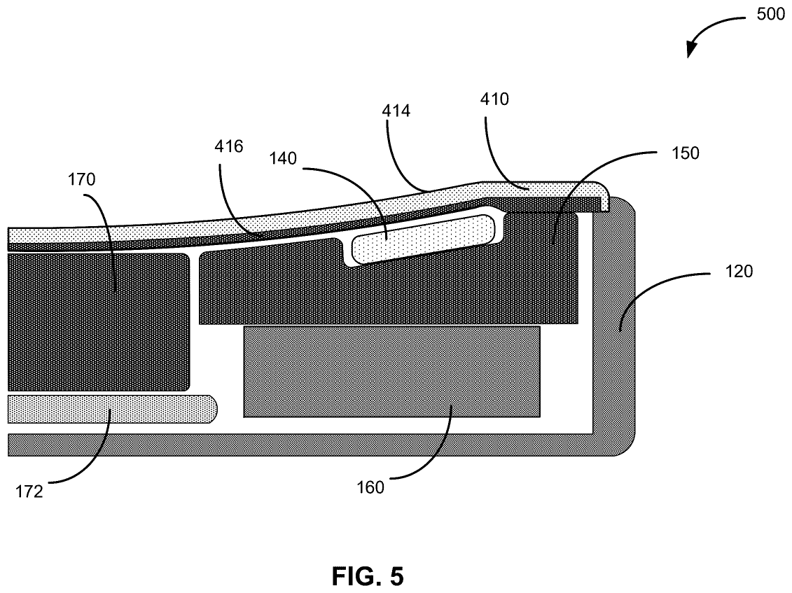

FIG. 4 illustrates another top cap according to an embodiment of the present invention. Top cap 410 can be formed using a two-shot process where a first shot forms a contacting surface 414 for interfacing with an electronic device while charging, and a second shot provides a conductive e-shield 416. Contacting surface 414 can be visible and can be made to have different colors as desired. Conductive e-shield 416 might not be visible and might not contribute to the appearance of charging puck 500 (shown in FIG. 5.) Contacting surface 414 can be a thermally conductive layer to help to remove heat from the electronic device while it is being charged. The first shot can form contacting surface 141, which can be formed of plastic, nylon-based plastic, or other material. Conductive e-shield 416 can be formed of plastic, nylon-based plastic, or other material that is doped with carbon, silver, or other material to provide the function of an e-shield. Top cap 410 can include tabs 412 to connect top cap 410 to housing 120 (shown in FIG. 1.)

FIG. 5 is another cutaway sideview of a portion of a charging puck according to an embodiment of the present invention. Charging puck 500 can include top cap 410 and housing 120. Top cap 410 and housing 120 can house magnet 170, magnetic shield 172, charging coil 140, ferrite 150, control electronics 160, a subset of these, or some or all of these and other components. Top cap 410 can include contacting surface 414 and conductive e-shield 416. Top cap 410 can be formed using a two-shot molding process. Contacting surface 414 can be formed using a first shot while conductive e-shield 416 can be formed using a second shot. Top cap 410 can connect to housing 120 or other conductive structure of charging puck 500 using a conductive glue or a conductive pressure sensitive adhesive (PSA.) In this way, the conductive glue or PSA can be used to bridge the connection from the conductive e-shield 416 of top cap 410 to system ground, which can be housing 120 or another part in the system. The glue or PSA can be attached to tabs 412, shown in FIG. 4.

The shots used to form top cap 410, and the other top caps shown herein, can be various types of molding shots in these and other embodiments of the present invention. For example, either or both the first and second shots can be formed by injection molding. Either or both the first and second shots can be formed by low-injection-pressure overmold (LIPO.) The use of LIPO can enable a layer to have a decreased thickness. This decreased thickness can help to increase an efficiency of the charging of an electronic device by a charging device, such as a charging puck.

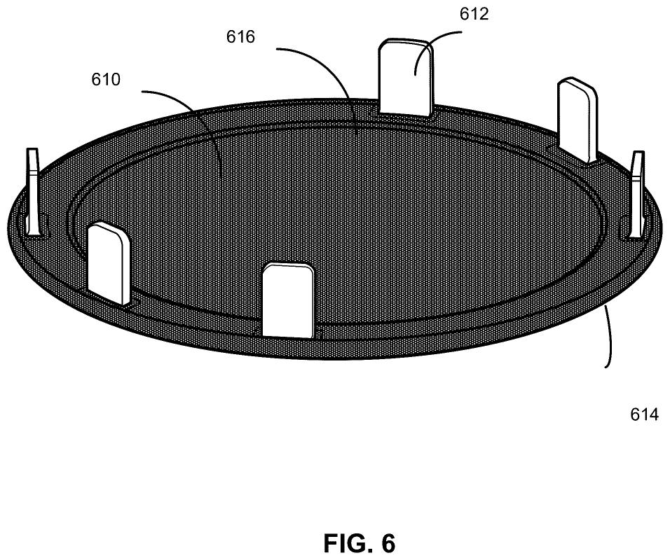

FIG. 6 illustrates another top cap according to an embodiment of the present invention. This top cap 610 can be formed of a thermally conductive layer 614 to help to remove heat from the electronic device while it is being charged. Thermally conductive layer 614 can be formed of plastic or other material. For example, thermally conductive layer 614 can be formed of a nylon-based plastic. An underside of the thermally conductive layer 614 of top cap 610 can be coated with e-shield 616, which can be a layer of carbon, silver, conductive ink, or other electrically conductive material. This layer forming e-shield 616 can also at least partially coat tabs 612 to enhance an electrical connection to housing 120. The coating for e-shield 616 can be formed by pad printing, vapor deposition, jet spraying, 3D printing, or other method. One or more layers of graphene can be placed on the underside of top cap 610. These various conductive layers forming e-shield 616 can have a sheet resistance on the order of between 100 and 1,000 ohms per square, or they can have another sheet resistance. This amount of resistance can be low enough to act as a e-shield to limit emissions while being high enough to limit eddy currents in top cap 610 that would otherwise reduce coupling efficiency.

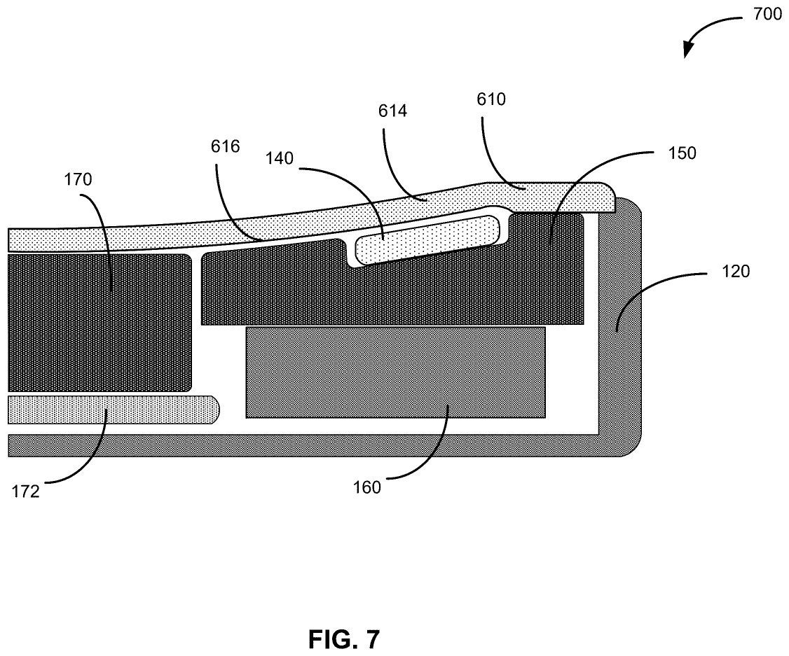

FIG. 7 is another cutaway sideview of a portion of a charging puck according to an embodiment of the present invention. Charging puck 700 can include top cap 610 and housing 120. Top cap 610 and housing 120 can house magnet 170, magnetic shield 172, charging coil 140, ferrite 150, control electronics 160, a subset of these, or some or all of these and other components. Top cap 610 can be formed of a resin or plastic layer to form thermally conductive layer 614. An underside of top cap 610 can be coated with a conductive layer to form e-shield 616. Top cap 610 can connect to housing 120 or other conductive structure of charging puck 700 using a conductive glue or a conductive pressure sensitive adhesive (PSA.) In this way, the conductive glue or PSA can be used to bridge the connection from the conductive coating forming e-shield 616 of top cap 610 to system ground, which can be housing 120 or another part in the system. The glue or PSA can be attached to tabs 612, shown in FIG. 6.

In these and other embodiments of the present invention, it can be desirable to provide a good contact area between top cap 610 and housing 120. That is, it can be desirable to provide a sufficient connection between top cap 610 and housing 120 of charging puck 700 in order to provide mechanical support for charging surface 618 of top cap 610 of charging puck 700, as well as to form a good electrical connection between e-shield 616 of top cap 610 and housing 120. An example is shown in the following figure.

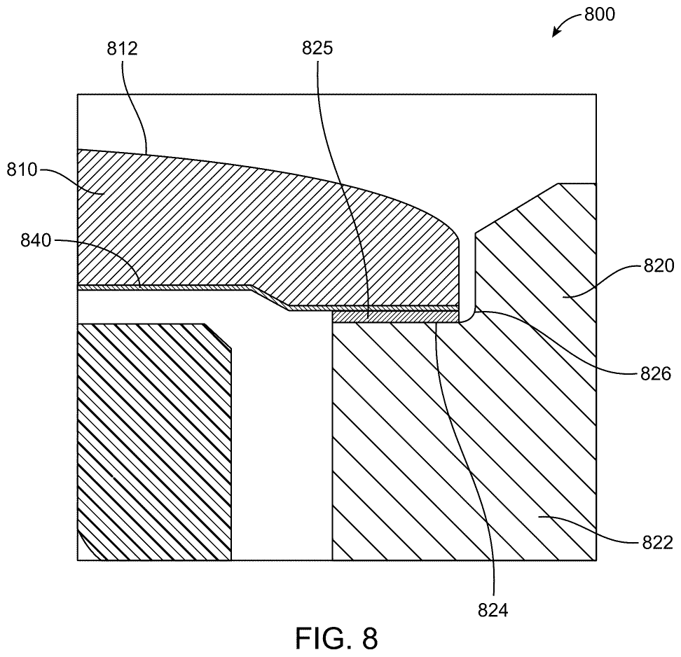

FIG. 8 illustrates a connection between a top cap and a housing for a charging puck according to an embodiment of the present invention. Charging puck 800 can include top cap 810 and housing 820. Top cap 810 and housing 820 can house magnet 170, magnetic shield 172, charging coil 140, ferrite 150, control electronics 160 (all shown in FIG. 1), a subset of these, or some or all of these and other components.

Top cap 810 can be formed of a thermally conductive nylon-based plastic or other plastic, glass-filled nylon, resin, or other material. E-shield 840 can be formed on the underside of top cap 810. E-shield 840 can be formed of conductive ink, carbon, silver, or other material. The coating for e-shield 840 can be formed by pad printing, vapor deposition, jet spraying, 3D printing, or other method. E-shield 840 can be formed of a layer of graphene. Using graphene can provide an e-shield with good thermal and electrical conductive properties. E-shield 840 can act to limit electromagnet interference and reduce electric fields at charging surface 812 of top cap 810 of charging puck 800, while permitting the passage of magnetic fields.

These and other embodiments of the present invention can provide a physical connection or contact between top cap 810 and housing 820 that can provide mechanical support for a device at charging surface 812, and can provide a good electrical connection between e-shield 840 and housing 820 in order to help improve shielding. In this example, notch 826 can be formed in a top of sidewall 822 of housing 820. Surface 824 of notch 826 can be at least partially coated with a layer of conductive glue 825. Surface 824 can be made to be fairly wide to provide a wide contacting area to e-shield 840 of top cap 810. This wide area can provide good mechanical support for an electronic device (not shown) positioned at contacting surface 812. The wide contacting area between e-shield 840 and surface 824 of housing 820 can provide a good electrical connection between them. The use of conductive glue can further improve the electrical connection. To further improve the electrical connection between e-shield 840 and surface 824 of housing 820, housing 820 can be formed of aluminum or other material that has been de-anodized.

E-shield 840 can be formed of a conductive material, such as conductive ink, or a layer of carbon, silver, conductive ink, or other electrically conductive material. As a result, eddy currents can build up in e-shield 840 causing a reduced efficiency in the wireless charging provided by charging puck 800. Accordingly, embodiments of the present invention can provide structures and techniques for reducing these eddy currents, thereby improving charging efficiency. As shown above, these techniques include using a layer having a higher sheet-resistance or impedance to reduce eddy current flow. Other examples can include providing nonconductive portions in e-shield 840 to block the formation of eddy currents, as well as splitting e-shield 840 into multiple conductive layers that are separated from each other, for example by insulation layers. Examples are shown in the following figure.

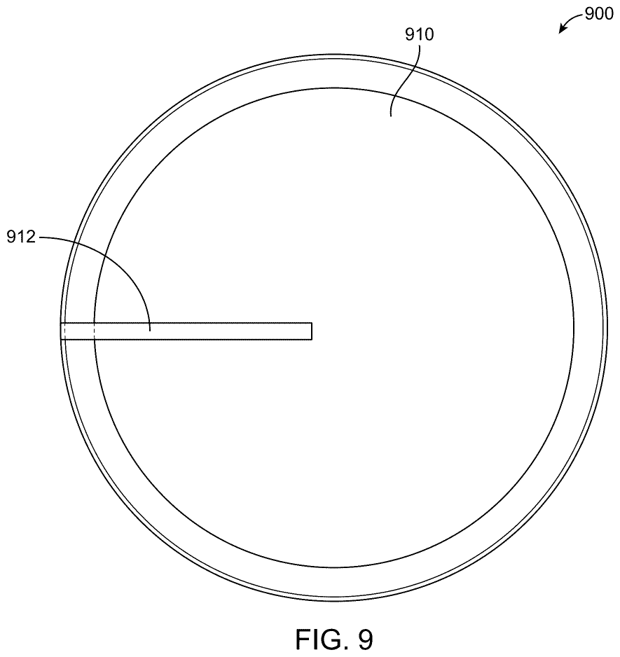

FIG. 9 illustrates a structure for reducing eddy currents in a conductive layer of a charging puck according to an embodiment of the present invention. In this example, top cap 900 can include an underside coated with a conductive material to form e-shield 910.

Electromagnetic fields generated by charging coil 140 (shown in FIG. 1) can be used to charge an electronic device positioned on a top surface (below e-shield 910 as drawn.) During this charging, electromagnetic fields from charging coil 140 can generate eddy currents in e-shield 910. These eddy currents can consume power that could otherwise be received by a corresponding charging coil in an electronic device being charged.

To help reduce these eddy currents, various features can be included in e-shield 910. Where the eddy currents are expected to follow a rough circular pattern, split 912 in e-shield 910 (where e-shield material is removed) can effectively interrupt the flow of electrons in e-shield 910, thereby improving efficiency. Other patterns can be implemented to interrupt circular or other patterns of eddy currents in e-shield 910. Also, instead of removing material to form split 912 or other pattern, a material having a higher resistance that can reduce electron flow can be used to form split 912 or other pattern.

In these and other embodiments of the present invention, other structures and techniques can be used to reduce these eddy currents. For example, carbon can be used to increase an impedance of an e-shield to reduce eddy currents and improve charging efficiency. In another example, multiple layers of conductive material can be used, where each layer has a lower conductivity to suppress eddy currents, while the combination of multiple layers can provide a desired amount of shielding to be provided by an e-shield. An example is shown in the following figure.

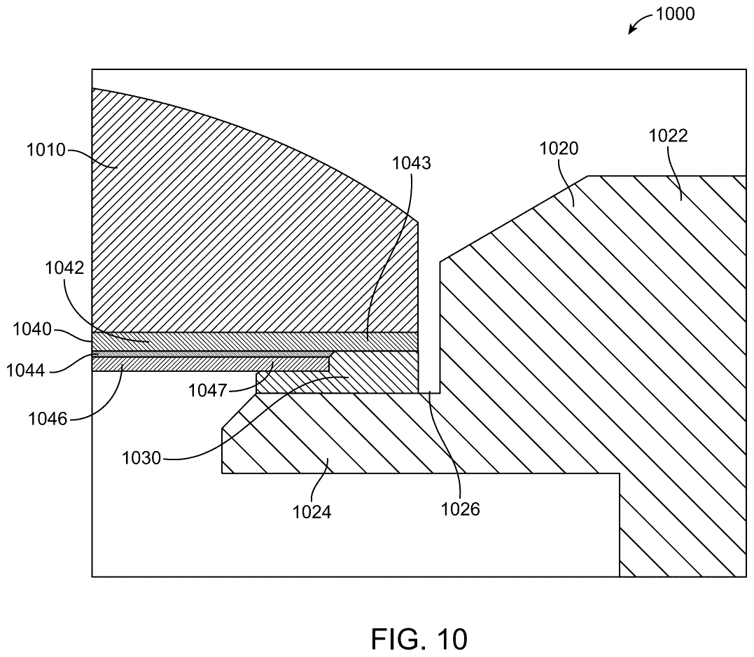

FIG. 10 illustrates another connection between a top cap and a housing for a charging puck according to an embodiment of the present invention. Charging puck 1000 can include top cap 1010 and housing 1020. Top cap 1010 and housing 1020 can house magnet 170, magnetic shield 172, charging coil 140, ferrite 150, control electronics 160 (all shown in FIG. 1), a subset of these, or some or all of these and other components. Top cap 1010 can include e-shield 1040 on a bottom side. E-shield 1040 can include conductive ink layer 1042 and conductive ink layer 1046. Conductive ink layer 1042 and conductive ink layer 1046 can be separated by insulation layer 1044. Instead of conductive ink, either or both layer 1042 and layer 1044 can be a layer of carbon, silver, graphene, or other electrically conductive material. Some or all of the layers, the conductive ink layer 1042, conductive ink layer 1046, and insulation layer 1044, can be formed by pad printing, vapor deposition, jet spraying, 3D printing, or other method.

Ledge 1024 can extend from, or be formed as part of, sidewall 1022 of housing 1020.

Conductive ink layer 1042 and conductive ink layer 1046 can be electrically connected to housing 1020 by conductive glue 1030. Conductive glue 1030 can electrically connect portion 1043 of conductive ink layer 1042 to surface 1026 of housing 1020. Conductive glue 1030 can further electrically connect portion 1047 of conductive ink layer 1046 to surface 1026 of housing 1020.

Conductive ink layer 1042 and conductive ink layer 1046 can both have an increased sheet-resistance to diminish the formation of eddy currents. To maintain this higher sheet-resistance, conductive ink layer 1042 and conductive ink layer 1046 of e-shield 1040 can be isolated or separated from each other by insulative layer 1044. This can further help to reduce eddy currents and increase charging efficiency. Further, the use of multiple layers can increase the shielding provided e-shield 1040, again increasing charging efficiency.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A charging device comprising:
a top cap to engage with an electronic device when the electronic device is charged by the charging device, wherein the top cap comprises a first material doped with a second conducive material, wherein the second conducive material provides conductivity to the top cap.

2. The charging device of claim 1 further comprising a housing to support the top cap.

3. The charging device of claim 2 further comprising a charging coil, wherein there is no intervening component between the charging coil and the top cap.

4. The charging device of claim 1 wherein the top cap is formed of a layer of resin doped with carbon.

5. The charging device of claim 1 wherein the top cap is formed of a layer of plastic doped with carbon.

6. The charging device of claim 5 wherein the layer of plastic is thermally conductive.

7. The charging device of claim 1 wherein the top cap is doped with one of carbon or silver.

8. A charging device comprising:
a top cap to engage with an electronic device when the electronic device is charged by the charging device, wherein the top cap comprises:
a first layer formed of a first material; and
a second layer formed of a second material doped with a third conducive material, wherein the third conducive material provides conductivity to the top cap.

9. The charging device of claim 8 further comprising a housing to support the top cap.

10. The charging device of claim 9 further comprising a charging coil, wherein there is no intervening component between the charging coil and the top cap.

11. The charging device of claim 8 wherein the first material is one or resin or plastic.

12. The charging device of claim 11 wherein the second material is one of resin or plastic.

13. The charging device of claim 12 wherein the third conducive material comprises one of carbon or silver.

14. The charging device of claim 8 wherein the top cap is formed using two-shot molding.

15. A charging device comprising:
a top cap to engage with an electronic device when the electronic device is charged by the charging device, wherein the top cap comprises:
a first layer formed of a first material; and
a conductive coating on an underside of the first layer.

16. The charging device of claim 15 further comprising a housing to support the top cap.

17. The charging device of claim 16 further comprising a charging coil, wherein there is no intervening component between the charging coil and the top cap.

18. The charging device of claim 16 wherein the first material is one of resin or plastic.

19. The charging device of claim 16 wherein the conductive coating is one of carbon or silver.

20. The charging device of claim 19 wherein the conductive coating is applied by one of pad printing, 3D printing, jet spraying, or vapor deposition.
